(19) United States
(12) Patent Application Publication
(10) Pub. No.: US 2019/0084707 A1
(43) Pub. Date: Mar. 21, 2019

(54) Filler Boot Diaphragm for Dairy Machines and the Like and Method of Making Same

(71) Applicant: Newman Sanitary Gasket Company, Lebanon, OH (US)

(72) Inventor: Richard P. Schroder, Lebanon, OH (US)

(21) Appl. No.: 16/135,125

(22) Filed: Sep. 19, 2018

Related U.S. Application Data
(60) Provisional application No. 62/560,412, filed on Sep. 19, 2017.

(51) Int. Cl. B65B 39/02; B67C 3/26; B67C 3/20; B29C 45/14

(52) U.S. Cl. CPC B65B 39/02; B67C 3/26; B29L 2031/755; B29C 45/14336; B67C 3/20

(57) ABSTRACT

An elastomeric casing encapsulates a reinforcing insert on a filler diaphragm for filling machines. The casing is molded onto the insert, the insert being completely encased in the lower end of the casing. At least one location port is provided in the lower end of the casing, and a plug is injected, inserted or over-molded in the location port.

### RELATED APPLICATION

The present non-provisional application claims the priority of U.S. Provisional Application No. 62/560,412 filed Sep. 19, 2017 bearing the same title as above.

### BACKGROUND

This invention relates to filling machines that are used to fill milk, juices and other products. The invention is an improvement in the design and method of making the diaphragms (or filler boots) that temporarily mate with containers (e.g. milk jugs) which pass through the machine. The diaphragms act as valves metering the fluid as it passes from product holding areas into the container that is eventually sold to the consumer.

As illustrated in FIG. 1, a filling machine 11 is provided with a multiplicity of diaphragms or boots 12 disposed between the spouts 14 and the bottles. Some conventional diaphragm designs have issues related to crevices (areas where fluid can be trapped) because of poor design, fabrication and wear and tear. As illustrated in FIGS. 3-6 prior art diaphragms which use inserts 18 or other materials inside of the elastomeric boot 12 can be particularly prone to crevices 20. Two common modes of crevice formation are illustrated in FIGS. 4 and 5. Sometimes there is polymeric material 22 that is left over from forming the diaphragm 12 in a mold, and it overspreads the insert 18. This is called “flash.” During use, the area over the insert is cleaned frequently, and the flash 22 gradually delaminates from the insert 18. Since the flash is thin and in the process fluid path, it may break off and go into the food product (contaminating the food product) or it may remain attached to the part and form a crevice 20 which is difficult to clean (FIG. 4). Even if this flash is removed by conventional means (e.g. by hand or machine), this leaves a seam which is exposed to the process and cleaning chemicals. When there is an exposed seam between the insert and the rubber-like diaphragm, the process and cleaning chemicals can degrade the adhesion of the rubber diaphragm to the insert. As the rubber pulls away from the insert it forms a crevice 24 that cannot be cleaned (FIG. 5). Cleaning chemicals may also become trapped in these crevices and contaminate the food product. When food products are trapped in these crevices, they may spoil, and harmful bacteria can begin to grow. Regulatory agencies track bacteria count regularly and can shut down filling lines that are deemed to be hazardous to the consumer. Crevices are a major source of this kind of risk to both the manufacturer and the consumer. Because of the risk, cleaning processes used for these boots are often aggressive and can contribute to making these crevices even larger, and premature part delamination and failure can occur.

### SUMMARY OF THE INVENTION

A diaphragm or filler boot may comprise at least one insert, an elastomeric molded casing having upper and lower ends, at least one location port in the lower end of the casing, and a plug injected, inserted or molded into the location port. The casing may be over molded onto and completely encase the insert in the lower end of the casing.

A method of making the filler boot may comprise forming at least one insert, molding the elastomeric casing having upper and lower ends onto the insert, said insert being completely encapsulated in the lower end of said casing; providing at least one location port in the lower end of the casing; and injecting, inserting or over-molding a plug into said at least one location port.

### BRIEF DESCRIPTION OF THE DRAWINGS

FIG. 1 is a perspective view of a filling machine and illustrates the diaphragms or filler boots interposed between the fluid-dispensing spouts on the machine and the bottles into which the fluid is dispensed;

FIG. 2 is a top view of a conventional filler boot;

FIG. 3 is a sectional view taken along line A-A of FIG. 2 and particularly illustrates an insert typically provided in the lower portion of the conventional filler boot;

FIG. 4 is a bottom view of the filler boot illustrates in FIGS. 2 and 3;

FIG. 5 is an enlarged detail view of crevice formation on the insert illustrated in FIG. 3;

FIG. 6 is an enlarged detail view of another mode of crevice formation on the insert illustrated in FIG. 3;

FIG. 7 is a top view of a filler boot according to an embodiment of the present invention;

FIG. 8 is a sectional view taken along line B-B of FIG. 7 and particularly illustrates encapsulation of the insert in the lower portion of the boot; and

FIG. 9 is a bottom view of the present filler boot illustrated in FIGS. 7 and 8.

### DETAILED DESCRIPTION OF THE PREFERRED EMBODIMENTS

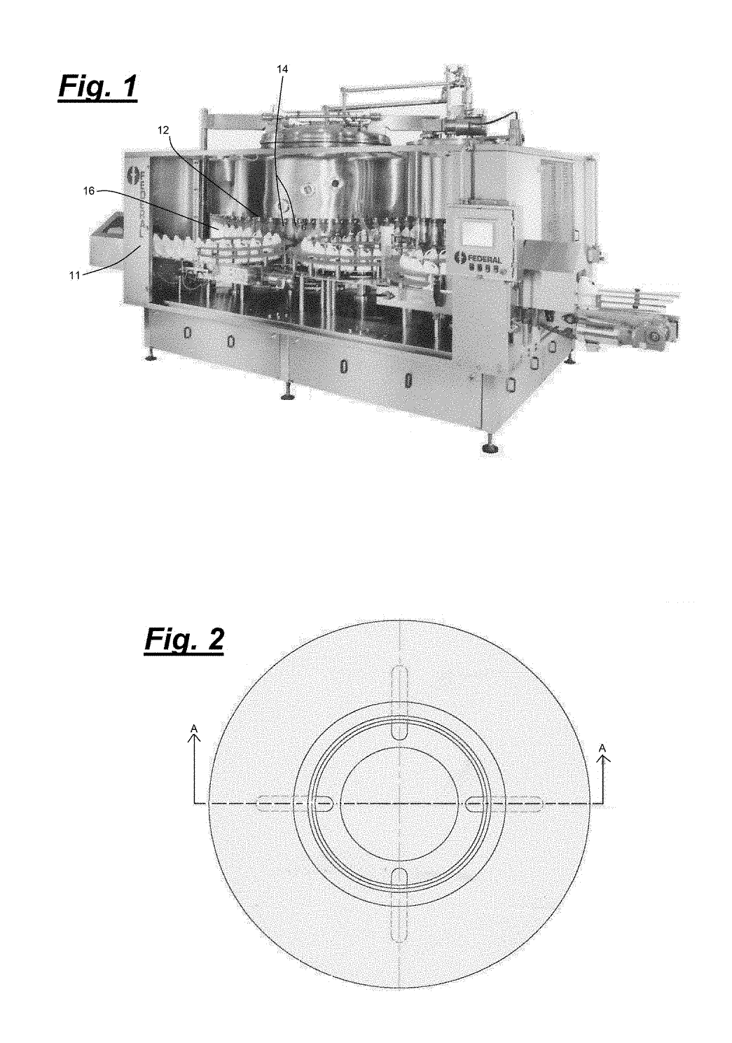

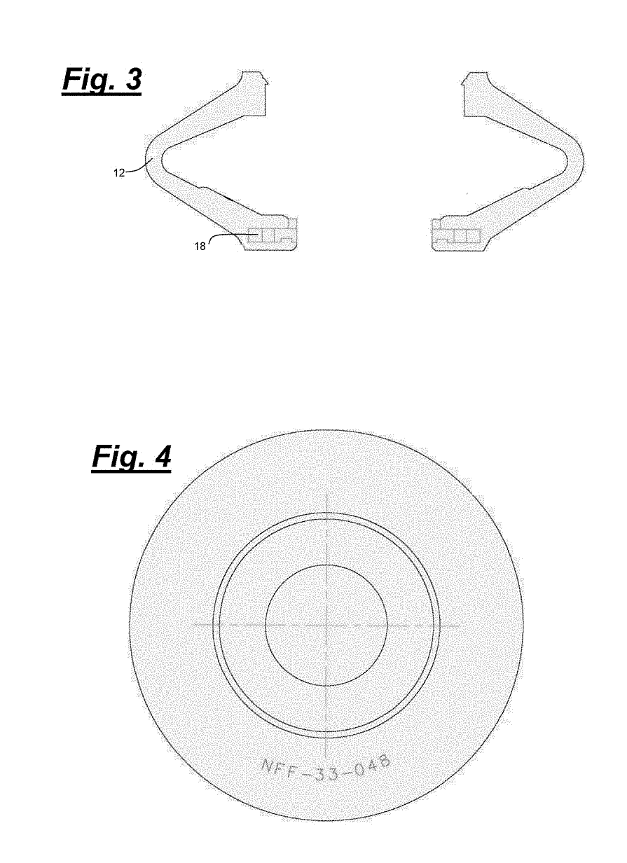

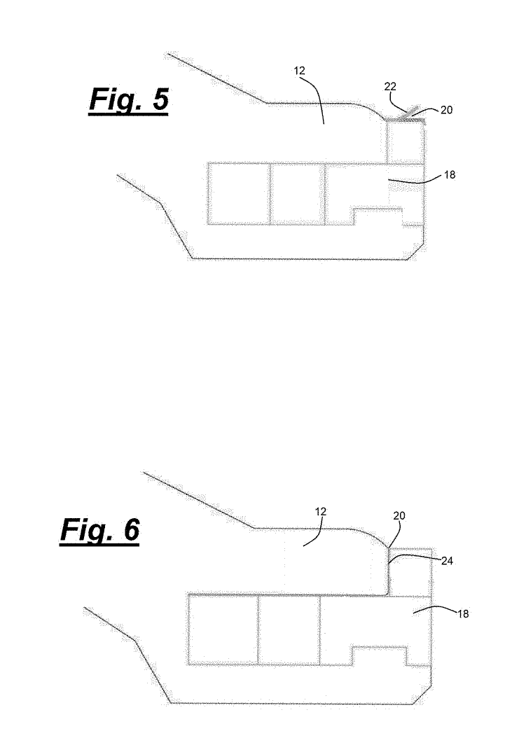

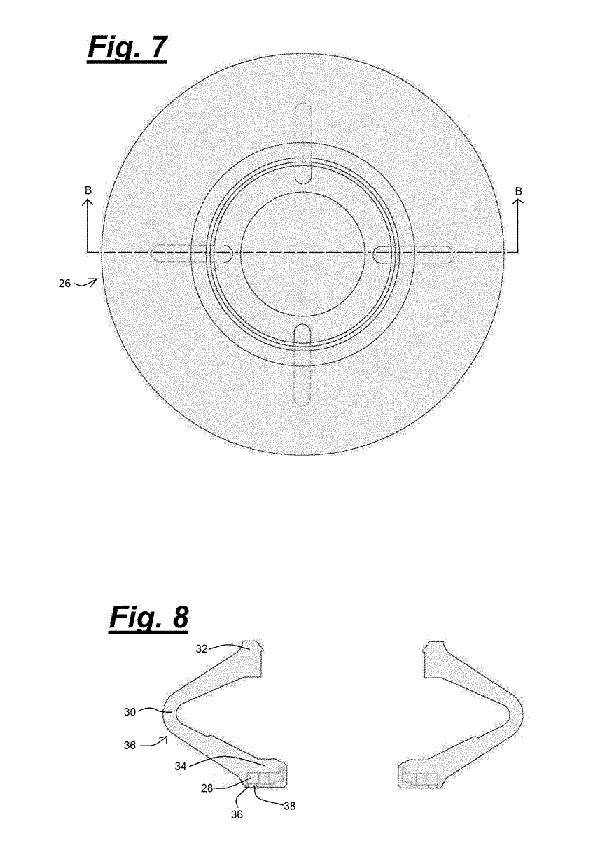

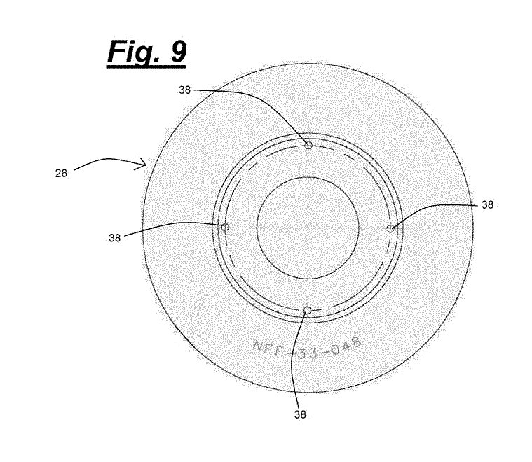

As illustrated in FIGS. 7-9, a diaphragm or filler boot, generally designated 26, is particularly adapted for use on a Federal Filling machine 11 (FIG. 1). The diaphragm may comprise at least one insert 28, an elastomeric casing 30 having upper 32 and lower ends 34, at least one location port 36 in the lower end of the casing, and a plug 38 injected, inserted or over-molded in the location port. The casing may be over molded onto and completely encase the insert in the lower end of the casing.

The present invention also encompasses a method of making the filler boot 26. The method may comprise forming at least one insert 28, molding the elastomeric casing 30 having upper 32 and lower ends 34 onto the insert, said insert being completely encapsulated in the lower end of said casing; providing at least one location port 36 in the lower end of the casing; and injection, inserting, or over-molding a plug 38 into said at least one injection port.

1. A diaphragm adapted to be mounted on a spout on a filling machine, said diaphragm comprising:
at least one insert;
an elastomeric casing adapted to be mounted on the spout of the filling machine, said casing having upper and lower ends and being over molded onto and completely encasing the insert in the lower end thereof;
at least one location port the lower end of the casing; and
a plug injected, inserted or over-molded in the location port.

2. A method of making a diaphragm adapted to be mounted on a spout on a filling machine, said method comprising:
forming at least one insert;
molding an elastomeric casing onto the insert, said casing having upper and lower ends, said insert being completely encapsulated in the lower end of said casing;
providing at least one location port in the lower end of the casing; and
injecting, inserting or over-molding a plug into said at least one injection port.
